(19) United States
(12) Patent Application Publication
(10) Pub. No.: US 2012/0113667 A1
(43) Pub. Date: May 10, 2012

(54) THIRD BRAKE LIGHT FOR A MOTOR VEHICLE AND METHOD FOR OPERATING A THIRD BRAKE LIGHT FOR A MOTOR VEHICLE

(75) Inventors: Peter BRANDT, Aschaffenburg (DE); Heiko CHARLE, Ruesselsheim (DE); Georg BAUER, Bergen-Enkheim (DE)

(73) Assignee: GM GLOBAL TECHNOLOGY OPERATIONS LLC, Detroit, MI (US)

(21) Appl. No.: 13/285,165

(22) Filed: Oct. 31, 2011

(30) Foreign Application Priority Data
Nov. 10, 2010 (DE) 102010050958.2

(51) Int. Cl. B60Q 1/44

(52) U.S. Cl. 362/541

(57) ABSTRACT

A third brake light for a motor vehicle includes, but is not limited to a light source, a light-guiding element with a decoupling structure defining a decoupling side of the light-guiding element, and an LCD-shutter. The LCD-shutter is arranged on a side of the light-guiding element facing away from the decoupling side.

### CROSS-REFERENCE TO RELATED APPLICATION

This application claims priority to German Patent Application No. 102010050958.2, filed Nov. 10, 2010, which is incorporated herein by reference in its entirety.

### TECHNICAL FIELD

The technical field relates to a third brake light for a motor vehicle, also called a center high mounted stop light and abbreviated CHMSL. Such brake lights partially have the disadvantage of obstructing the vision of the driver to the back or dazzle the driver.

### BACKGROUND

From U.S. Pat. No. 5,347,435 A it is known to represent the third brake light by means of a hologram, so that no or only few compact installations have to be carried out in the region of the back window.

At least one object is to state a third brake light for a motor vehicle that is preferably technically simple, which in the event of braking has good visibility, but which at the same time does not dazzle the driver and unnecessarily obstruct his vision to the back. In addition, it is at least a further object to state a method for operating such a brake light. In addition, other objects, desirable features and characteristics will become apparent from the subsequent summary and detailed description, and the appended claims, taken in conjunction with the accompanying drawings and this background.

### SUMMARY

A third brake light is provided for a motor vehicle, which comprises at least one light source and at least one light-guiding element. The light-guiding element comprises a decoupling structure for light. This decoupling structure defines a decoupling side of the light-guiding element on which the light preferably leaves the light-guiding element. The third brake light furthermore comprises an LCD-shutter, wherein the LCD-shutter is arranged on a side of the light-guiding element facing away from the decoupling side.

Here and in the following an LCD-shutter is to mean a liquid crystal display that can be switched into an at least largely transparent and into an at least largely opaque state. For such LCDs, which for example are employed with 3D spectacles, the term “shutter” is also being used in the German-speaking area since they can be employed like a shudder.

The at least one light source can, for example, be designed as light emitting diode (LED), wherein in an embodiment it comprises a multiplicity of micro-LEDs. Here and in the following, micro-LEDs is to mean LEDs whose diameter amounts to only a few, for example approximately 2 millimeters, so that they have a quasi dot-shaped effect.

In an embodiment, the light-guiding element is designed as disc. Here and in the following, a disc is to mean a relatively flat body which has two main surfaces with any contour, for example round, rectangular or oval, located opposite each other.

In an embodiment the light-guiding element comprises nano-particles embedded in a matrix as decoupling structure. This has the advantage that the decoupling structure is not or hardly visible, so that the light-guiding element can appear simply transparent and is very unobtrusive. Alternatively or additionally the light-guiding element can comprise a three-dimensional decoupling structure in its volume or on its surface which causes a scattering or refraction of the light preferably in the direction of the decoupling side.

In an embodiment the at least one light source is arranged relative to the disc in such a manner that light is laterally coupled into the disc via a narrow side of the disc. This arrangement is particularly appropriate if only few or even only one light source is used. A lateral coupling-in of this type has the advantage that the light source used can be arranged distant from the disc and the shutter at a suitable place, wherein if necessary a light guide such as for example a fiber can be used for transporting its light. Alternatively, the at least one light source can also be arranged relative to the disc in such a manner that its light is coupled into the latter via a main surface of the disc. This arrangement is particularly suitable when a multiplicity of micro-LEDs is used as light source. In the non-illuminating state these are unobtrusive such that they can be arranged in the field of vision of the driver. Both types of arrangements can also be combined, for example in order to amplify the brightness of the third brake light or in order to realize an adaptive brake light with different possible intensities.

In an embodiment the LCD-shutter is designed as TN-cell. A twisted nematic (TN) cell, which in German is also called Schadt-Helfrich cell, is a liquid crystal display wherein the liquid crystal is arranged between two polarization filters. If an electric voltage is applied to the liquid crystal, the liquid crystals orientate themselves parallel to the field and incoming light passes through without turning of the polarization direction. In the de-energized state by contrast a twisted structure of, for example 90°, which causes a rotation of the polarization of the incoming light. If the polarization filters are arranged parallel to each other, the cell without voltage is opaque and becomes transparent only with increasing voltage (normally black mode). In the normally white mode by contrast the polarization filters are arranged rotated relative to each other and the cell is transparent in the de-energized state. For the use in the third brake light the transparent state typically constitutes the normal case seen with respect to time and the opaque state the exception, which is why a TN-cell normally designed in the normally white mode, is preferably employed in an embodiment.

The third brake light has the advantage that it is clearly visible from following vehicles but without dazzling the driver at the same time. Since the LCD-shutter is closed only upon actuating the brake, i.e., when the brake light lights up and the third brake light is otherwise substantially transparent, the vision of the driver is impaired as little as possible.

According to another embodiment, the described third brake light is employed in a motor vehicle. According to a further embodiment, a method for operating a third brake light of a motor vehicle is stated, where light is directed into a radiation direction and in a direction against the radiation direction the radiation of light is prevented by means of an LCD-shutter.

In an embodiment, the LCD-shutter is switched opaque when the brake light is switched on, and transparent, when the brake light is switched off

The guiding can be effected by means of nano-particles embedded in a matrix and/or by means of three-dimensional decoupling structures in the volume or on the surface of a light guide. The light can be generated for example by means of LEDs arranged laterally next to a light-guiding element and the LCD-shutter or by means of LEDs arranged areally distributed next to a main surface of a light-guiding element designed as disc and laterally or areally coupled into the light-guiding element.

### BRIEF DESCRIPTION OF THE DRAWINGS

The present invention will hereinafter be described in conjunction with the following drawing figures, wherein like numerals denote like elements, and:

FIG. 1 schematically shows the construction of a third brake light according to a first embodiment; and

FIG. 2 schematically shows the construction of a third brake light according to a second embodiment.

### DETAILED DESCRIPTION

The following detailed description is merely exemplary in nature and is not intended to limit application and uses. Furthermore, there is no intention to be bound by any theory presented in the preceding background or summary or the following detailed description.

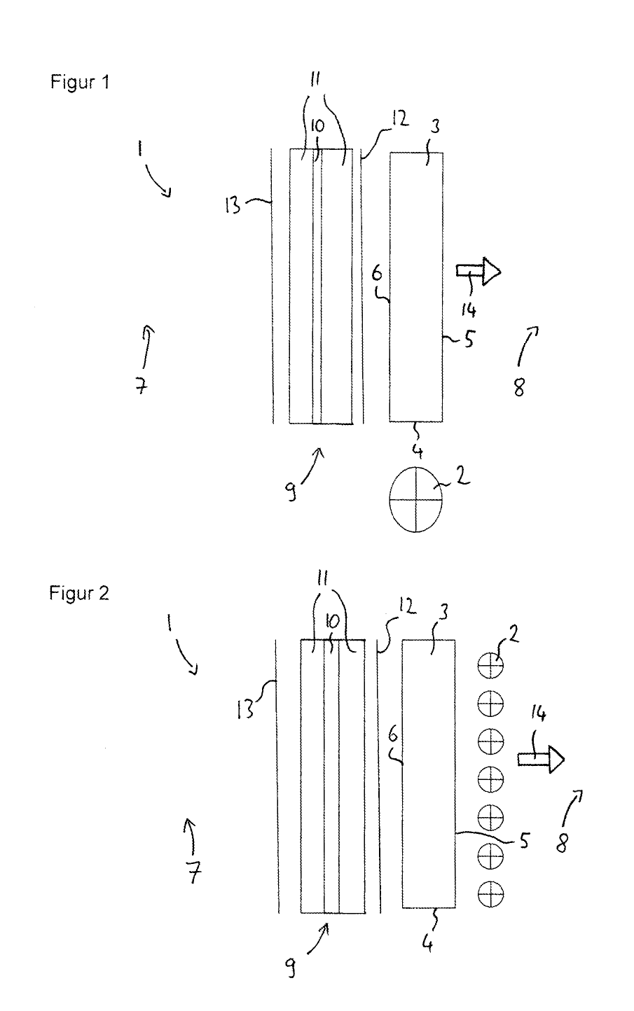

The third brake light 1 according to FIG. 1 is arranged on the inside of a back window of a vehicle which is not shown here, which separates the vehicle interior 7 from the outside 8. An arrangement on the outside of the back window or integration in the back window is likewise conceivable.

The third brake light 1 comprises a light source designed as LED 2 and a disc-shaped light-guiding element 3, which comprises two main surfaces 5, 6 located opposite each other and narrow sides 4. By way of one of the narrow sides 4 the light of the laterally arranged LED 2 is coupled into the light-guiding element 3.

The light-guiding element 3 comprises a plastic matrix with nano-particles embedded therein, which act as scattering centers in a decoupling structure and cause an areal radiation of the coupled-in light. Accordingly, the light is coupled out substantially evenly over the main surfaces 5, 6 and the narrow sides 4, however at least via the main surface 5 serving as decoupling side in the direction of the arrow 14.

In order to avoid an impairment of the driver through the light radiated into the vehicle interior 7 an LCD-shutter 9 mounted between the light-guiding element 3 and the vehicle interior 7 is provided, which is closed upon activation of the third brake light 1.

The LCD-shutter 9 is designed as TN-cell and in the know manner comprises a liquid crystal film 10, which is arranged between two glass plates 11 with a coating serving as electrode. The LCD-shutter 9 furthermore comprises a first polarization filter 12 arranged between the light-guiding element 3 and the glass plate 11 and a second polarization filter 13 arranged between the glass plate 11 and the vehicle interior 7. The first polarization filter 12 and the second polarization filter 13 are arranged rotated relative to each other by 90 degrees, so that the LCD-shutter 9 in the de-energized state is open and thus transparent.

In operation, the third brake light 1 is activated upon braking of the vehicle and the LED 2 emits red light. The light is coupled into the light-guiding element 3 and areally radiated, particularly in the direction of the arrow 14. Upon activation of the third brake light 1 the LCD-shutter 9 is closed in that an adequately high voltage is applied in order to align the molecules of the liquid crystal 10 in parallel. The light radiated through the light-guiding element 3 can no longer pass through the second polarization filter 13 because of its polarization direction and the LCD-shutter 9 becomes opaque.

Once braking is completed, the third brake light 1 is deactivated so that the LED 2 no longer radiates any light. The LCD-shutter 9 is also de-energized so that the molecules in the liquid crystal 10 realign themselves in a twisted structure along which the polarization direction of the incoming light rotates so that it can pass the second polarization filter 13. The LCD-shutter 9 is thus transparent again.

The third brake light 1 according to the second embodiment shown in FIG. 2 differs from the one shown in FIG. 1 in the light sources used and in the type of coupling-in of the light in the light-guiding element 3. According to the second embodiment, a multiplicity of micro-LEDs 2 are provided as light source, which are arranged along the main surface 5 of the light-guiding element 3. In an embodiment that is not shown these are arranged along the other main surface 6.

There light is coupled into the light-guiding element 3 via the main surface 5, scattered in its volume of nano-particles and areally illuminated again via the main surface 5. The mode of operation of the LCD-shutter 9 and the operation of the third brake light 1 otherwise corresponds to that of the first embodiment.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A third brake light for a motor vehicle, comprising:
a light source;
a light-guiding element with a decoupling structure defining a decoupling side of the light-guiding element; and
a LCD-shutter arranged on a side of the light-guiding element facing away from the decoupling side.

2. The third brake light according to claim 1, wherein the light source comprises a LED.

3. The third brake light according to claim 1, wherein the light source comprises a multiplicity of micro-LEDs.

4. The third brake light according to claim 1, wherein the light-guiding element is a disc.

5. The third brake light according to claim 1, wherein the light-guiding element comprises nano-particles embedded in a matrix as the decoupling structure.

6. The third brake light according to claim 1, wherein the light-guiding element comprises a three-dimensional decoupling structure in a volume of the light-guiding element.

7. The third brake light according to claim 1, wherein the light-guiding element comprises a three-dimensional decoupling structure on a surface of the light-guiding element.

8. The third brake light according to claim 4, wherein the light source is arranged relative to the disc in such a manner that light is coupled into the disc via a narrow side of the disc.

9. The third brake light according to claim 4, wherein the light source is arranged relative to the disc in such a manner that light is coupled into the disc via a main surface of the disc.

10. The third brake light according to claim 1, wherein the LCD-shutter is a TN-cell.

11. A method for operating a third brake light of a motor vehicle, directing light into a radiation direction; and
preventing a radiation of light with an LCD-shutter in a direction against the radiation direction.

12. The method according to claim 11, further comprising:
switching the LCD-shutter to opaque when a brake light is switched on; and
switching the LCD-shutter to transparent when the brake light is switched off

13. The method according to claim 11, further comprising affecting light guidance with nano-particles embedded in a matrix.

14. The method according to claim 11, further comprising affecting light guidance with three-dimensional decoupling structures in a volume a light-guiding element.

15. The method according to claim 11, further comprising affecting light guidance with three-dimensional decoupling structures on a surface of a light-guiding element.

16. The method according to any claim 11, generating the light is generated with LEDs arranged laterally next to a light-guiding element configured as a disc

17. The method according to any claim 11, generating the light is generated with LEDs arranged between a light-guiding element designed as disc and the LCD-shutter.

18. The method according to any claim 11, generating the light is generated with LEDs arranged areally distributed next to a main surface of a light-guiding element designed as disc.
